(19) United States
(12) Patent Application Publication
(10) Pub. No.: US 2020/0368642 A1
(43) Pub. Date: Nov. 26, 2020

(54) OPTIMIZATION OF WET SCRUBBER PROCESS FLOWS THROUGH ONLINE MEASUREMENT AND CONTROL OF GASES ENTRAINED IN THE SCRUBBER LIQUID

(71) Applicant: Buckman Laboratories International, Inc., Memphis, TN (US)

(72) Inventors: Bret Magness, Collierville, TN (US); Jim Turnbull, Memphis, TN (US); Mike McKinney, Memphis, TN (US); John Kurtz, Memphis, TN (US); Darrell Rose, Memphis, TN (US)

(21) Appl. No.: 16/879,168

(22) Filed: May 20, 2020

Related U.S. Application Data
(60) Provisional application No. 62/850,396, filed on May 20, 2019.

(51) Int. Cl. B01D 19/00; B01D 53/14; B01D 53/18; B01D 53/80; B01D 19/04

(52) U.S. Cl. CPC B01D 19/0063; B01D 53/1412; B01D 53/18; B01D 2251/606; B01D 19/04; B01D 2251/404; B01D 53/80

(57) ABSTRACT

A system and method for reducing foaming in a wet scrubber system. The system utilizes a device for measuring the volume of entrained gas in the wet scrubbing system, and automatically or semi-automatically adjusting one or more process parameters including: a flow rate of antifoam/defoamer chemistry in said wet scrubber; a flow rate of flue gas; and a flow rate of fresh water. The system allows real-time monitoring and control of the foam in said wet scrubber.

### CROSS REFERENCE TO RELATED APPLICATIONS

The present invention claims priority to U.S. Provisional Patent Application No. 62/850,396, filed May 20, 2019, and to U.S. Provisional Patent Application No. 62/948,609, filed Dec. 16, 2019, both of which are incorporated herein by reference in their entireties.

### BACKGROUND OF THE INVENTION

### Field of the Invention

The invention relates primarily to systems and methods for improvement of wet scrubbing systems. More specifically, the present invention is a system for reduction of foaming in the wet scrubber system based on real-time measurement of entrained gas and adjustment of application of chemical additives and other processing parameters based on such measurement.

### Description of the Background

Wet scrubbers are employed across many industries for removal of particulates and harmful gases from the flue gas or exhaust gas streams exiting processes. There are many differing designs for wet scrubbers, but all rely on passing exiting gas streams (containing particulate or gaseous pollutants from the waste stream of an industrial process) through a scrubbing liquid for removal of the target particulates and/or gases from the exiting gas stream. A variety of scrubbing liquids are known in the art for various applications, depending on the nature and quality of the particulates and/or gasses targeted for removal. Many of the known scrubbing liquid formulations are prone to foaming under the processing conditions characterizing the standard wet scrubbing operation. Entrained gas in, and foam arising from, scrubbing liquids in the wet scrubbing operation are comprised of gas in the form of small bubbles contained in a liquid continuous mixture.

Excessive gas entrainment and foaming in the wet scrubbing operation results in performance losses, caused by various factors including supply pump cavitation and effluent excursions and corrosion in areas not designed to handle the scrubber liquid. Supply pump cavitation will reduce recirculation flow to the scrubber, reducing the capacity of the scrubber to perform. This loss of recirculation flow can cause scrubber performance excursion and potential permit violation.

Wet scrubber operators currently rely on a couple of different techniques for managing foaming and cavitation around scrubbers. These include: (a) continuous base loading of antifoam/defoamer chemistry to the showering systems or recirculation liquid, (b) periodically adding fresh water to the system, paired with additional system blowdown, and (c) periodically discontinuing or reducing the feed to the scrubber. Of the above, methods (b) and (c) have the obvious drawback that the scrubber's operation must be stopped during the process. In many cases, this may also require the temporary cessation of the production process(es) whose exhaust gasses the scrubber in question is designed to treat. In addition, method (a), the continuous base loading of defoamer chemistries, may limit the ability of the scrubbing liquid to maintain a level of entrained oxygen that is necessary to make the oxidation reactions of some scrubbers efficient, thereby limiting the performance of the scrubber. This dosing method also contributes to higher operational cost of the scrubber.

Unfortunately, current systems apply such foaming control technique(s) on an as-needed, ad hoc, or pre-programmed basis, often causing excess processing line shutdowns to combat perceived foaming problem(s), overuse of antifoam/defoamer chemistry, and/or underuse of the above techniques when needed, resulting in excess foaming and resultant performance losses.

It would be advantageous to have a system capable of determining the appropriate level of antifoam/defoamer chemistry needed in the system, and/or the appropriate blowdown schedule or frequency, and automatically applying, controlling, or alerting the operator to the need for a given foam control technique to improve overall efficiency of the system and related industrial process. This system would ideally be able to control/limit excessive entrained gas levels, while also limiting periods of low entrained gas that inhibit optimal oxidation reaction performance.

### SUMMARY OF THE INVENTION

Accordingly, the present invention is a system and method for active optimization of foam control operations by real-time monitoring and control of gas content in the wet scrubber system.

The foregoing objects, features and attendant benefits of this invention will, in part, be pointed out with particularity and will become more readily appreciated as the same become better understood by reference to the following detailed description of a preferred embodiment and certain modifications thereof when taken in conjunction with the accompanying drawings.

### BRIEF DESCRIPTION OF THE DRAWINGS

In the drawings:

FIG. 1 is a schematic diagram of a preferred embodiment of the inventive system, showing the system as applied to a recirculation basin 100 for scrubbing liquid which may be used in connection with known wet scrubbing operations.

FIG. 2 is a diagram of one embodiment of the inventive system as applied to three recirculation basins 100 fueling three recirculation pumps each supplying scrubber liquid to the wet scrubber spray tower.

### DETAILED DESCRIPTION OF THE PREFERRED EMBODIMENTS

The present invention includes a system and methods for automated control of the entrained gas present in the recirculation system of the wet scrubber using real time, on-line measurement. Automated measurement and control of this entrained gas will increase the efficiency of the wet scrubber by reducing the negative impacts of foam control measures on the scrubber's operation, and as a result will likely enhance the performance of the industrial process as a whole to which the scrubber is applied.

This online measurement provides real time advantages over current practices. Online measurement of the entrained gas present allows for real time adjustment of scrubber parameters as entrained gas levels vary. As described above, present foam control systems are used on an as-needed, ad hoc, or pre-programmed basis, often causing excess processing line shutdowns to combat perceived foaming problem(s), overuse of antifoam/defoamer chemistry which limits the efficiency of the oxidation reaction in the scrubber, and/or underuse of the above techniques when needed. The present invention provides automated or near-automated control and adjustment of defoamer/antifoam chemistry dosage in real time to control the volume of entrained gas in the scrubber system. The present invention also provides automated or near-automated control and adjustment of blowdown, air injection rate (on equipped scrubbers) or downtime schedule or frequency, to minimize such downtime as much as possible while preventing excess foam buildup that could harm processing equipment and cause scrubbing inefficiencies or permit violations.

The system according to the present invention includes an entrained air measurement device such as that described in U.S. Pat. No. 8,109,127, the entirety of which is incorporated herein by reference. The device described in U.S. Pat. No. 8,109,127 uses sonar to measure the volume of entrained gas in a liquid process stream, during processing, in real time. Other devices capable of providing a measurement of entrained gas in a processing feed may also be used in the inventive system described herein.

In addition, the inventive system includes a processor capable of receiving, recording and processing data received by the entrained air measurement device. In preferred embodiments, the processor is also operatively connected to controllers for altering various processing parameters in the wet scrubbing system, such as the feed rate(s) for various additive feeds to the wet scrubber, including antifoam/defoamer chemistries, fresh water, flue gas, scrubber liquid, and/or air injection. Also in preferred embodiments, the processor is operatively connected to sensors for other processing parameters, such as sensors to measure the actual feed rate of the various processing/additive lines mentioned above, sensors to measure environmental conditions, sensors that measure the volume of pollutants in the exhaust stream, and sensors to measure conductivity, chlorides, and/or pH in the scrubbing system.

For example, the schedule and frequency of blowdowns in the wet scrubbing systems of coal plants (e.g., in the recirculation basin or vessel) are often driven by conductivity and chlorides, as high levels of these metrics can inhibit reaction performance. In other applications of wet scrubbing systems, such as corn mills, the schedule and frequency of blowdowns may be driven by pH measured in the recirculation basin or vessel because certain reactions will drive pH to a point where the reaction is not producing the desired end products (improper reaction).

The inventive measurement and control system may be applied to any wet scrubber, that is, a wet scrubber which uses a liquid to scrub contaminants from a gas stream. This includes wet scrubbers which use limestone slurries are used as a scrubbing “aid”. Other scrubbing aids, such as Caustic or caustic soda, may be used in the scrubber to which the inventive system is applied as desired by one of skill in the art.

In operation, the inventive system monitors the volume of entrained gas in the wet scrubber on a continuous basis, in real time, and adjusts/optimizes the entrained gas volume by control of the various available processing parameters. Such control can take place either automatically by operative control of the system over controls, or manually by the operator based on direction received by the system for real-time adjustment of processing parameters.

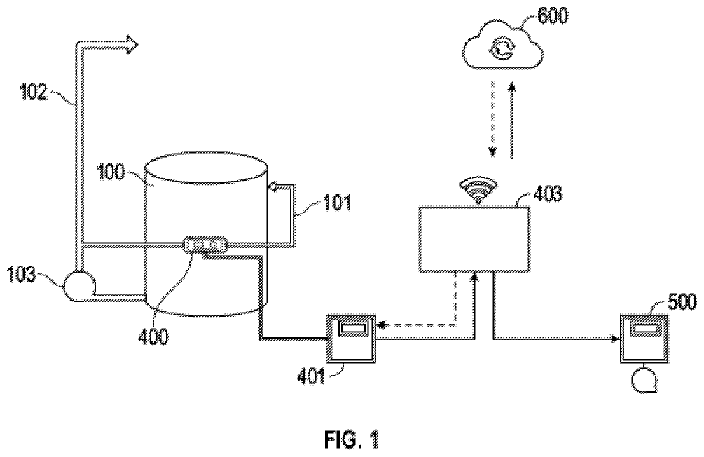

FIG. 1 is a schematic diagram of an exemplary recirculation basin 100 for scrubbing liquid which may be used in connection with known wet scrubbing operations. As shown, scrubbing liquid is received in the recirculation basin 100 before being pumped via recirculation pump 103 through recirculation line 102 back to the wet scrubbing tower, where the scrubbing reaction between scrubbing liquid and exhaust gas takes place. During this recirculation process, in certain prior art systems, the pH of the scrubbing liquid is sampled. FIG. 1 illustrates a system in which a sample is taken off of recirculation line 102 after pump 103, however it will be understood that other configurations are possible if not explicitly described in the prior art. As illustrated, the pH of the scrubbing liquid is sampled (not shown) before being returned to the recirculation basin for eventual return to the recirculation tower. In this example, an entrained gas measuring device 400 is located on the pH sample line 101, whereby scrubbing liquid flowing through pH sample line 101 is representative of the scrubbing liquid then present in the entire system. However, the invention contemplates several possible locations of the entrained gas measuring device or devices 400 which can provide adequate measurement of entrained gas levels in the scrubbing liquid as needed to operate the disclosed system and carry out the inventive methods described herein. Locating an entrained gas measuring device at any location within the system where it is possible to either obtain a discrete sample or inline measurement of scrubbing liquid in the system, or even to embed an entrained gas measuring device in the wall of a reaction vessel or other system component, falls within the scope of the present invention. For example, the entrained gas measuring device can be installed in an existing sample line, a pH measurement line (as shown), any other sample line, for example one that pulls a sample directly from the scrubber basin, on a line adjacent to other instruments such as pH, ORP, or densometer, directly on the recirculation lines, directly in the wall of the recirculation basin, or on a continuous blowdown.

Regardless of where the one or more entrained gas measuring device(s) are located within the system, they are continuously (or at regular intervals) measuring entrained gas levels of the scrubbing liquid. Depending on the type of entrained gas measuring device used, the output from the device 400 can be transmitted to a centralized control station by known means compatible therewith. In FIG. 1, a sensor head/transmitter unit 401 is hard wired to each entrained gas measuring device 400, and sends either wired or wireless signals to various additional control units as described herein for carrying out the method of real-time active control of entrained gas levels. For example, transmitter 401 is shown in FIG. 1 as being operatively connected (via a controller unit 403) to the drive unit of a defoamer pump 500 for controlling the level of defoamer/anti-foam chemistry supplied to the system based on the readout from the entrained gas measuring device 400. Additionally, connections, which may be wired or wireless, are shown between transmitter 401 and a main plant control center 600 where output from one or more entrained gas measuring devices 400, coupled with other plant data or sensor readouts, as available, can be processed and adjusted to determine optimum levels for one or more defoamer pumps 500 plant-wide (not shown), and to other active control mechanisms including but not limited to the feed rate(s) for various additive feeds to the wet scrubber, including fresh water, flue gas, scrubber liquid, blowdown and/or air injection, or to control or inform downtime schedule or frequency. In preferred embodiments, connections between said transmitter 401 and foam control element 500 and/or main plant control center 600 are routed through controller 403, which includes a processor running applications designed to output control signals to the various foam control devices and other system-wide control devices based on inputs received from the entrained gas measuring device 400 and pre-programmed control algorithms. Also in certain embodiments of the invention, instead of a defoamer pump, element 500 in FIG. 1 could represent another primary control mechanism operatively connected to said entrained gas measuring device 400, such as an air fan, blowdown valve, air injection valve, or like devices that can impact the level of foam in the system.

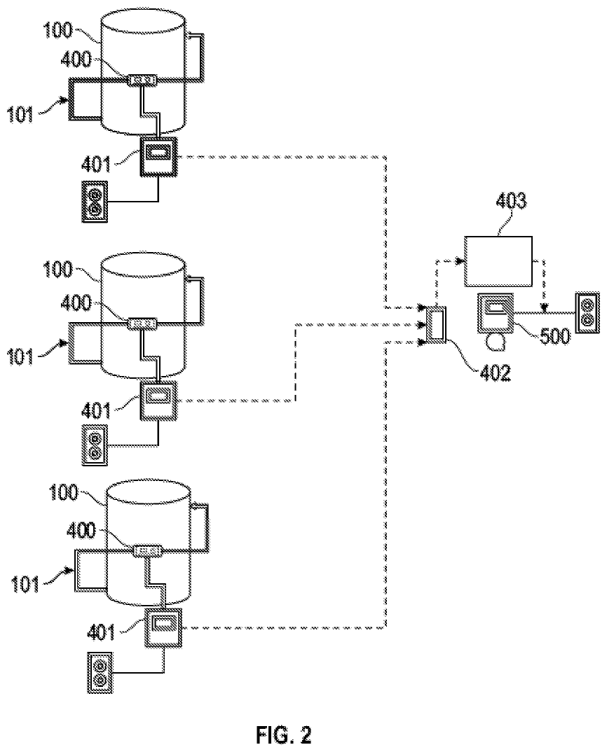

FIG. 2 is a diagram of the system as applied to three recirculation basins 100 fueling three recirculation pumps (not shown in FIG. 2) each supplying scrubber liquid to the wet scrubber spray tower. FIG. 2 illustrates how data from multiple entrained gas measuring devices 400, each installed on a pH sample line of a separate recirculation basin 100 (although other configurations or locations of entrained gas measuring devices 400 are possible, as described above), can be used to provide control signals to a single defoamer pump 500 or other control device. As shown, the transmitters 401 for the three entrained gas measuring devices 400 are connected (wired or wirelessly) to an optional receiver 402 associated with controller 403 and a defoamer pump 500 supplying defoamer chemistry to the gas scrubbing system, or other foam control device(s) as described above. Although not shown in FIG. 2, each of the entrained gas measuring devices 400 (or their associated transmitters 401) can be wired or wirelessly connected with a main plant control center or a sub-center dedicated to this portion of the operation whereby signals received from multiple entrained gas measuring devices (and other sensors as available) are collected and any computation or analysis operations take place to provide control signals to the defoamer pump 500 or other active control mechanisms as described herein.

Thus, the system continuously receives inputs from at least an entrained gas measuring device, and in certain embodiments, from other sensors associated with the wet scrubber's operation such as one or more of those described herein, including conductivity, chlorides and pH sensors. In response to those measurements, the inventive system provides one or more outputs to control or direct the control of foam control measures or other processing parameters.

In some preferred embodiments, the system functions automatically. Thus, the controller 403 according to the present invention includes a processor running software application(s) with one or more control algorithms for controlling, in real time, at least one of the following: flow rate of antifoam/defoamer chemistry into the wet scrubbing system; flow rate of fresh water into the wet scrubbing system; feed rate of flue gas into the wet scrubbing system; feed rate of pressurized gas for blowdown of the wet scrubbing system. In preferred embodiments, and as described, defoamer dosing control is accomplished using a controller paired with a variable frequency drive connected to a defoamer dosing pump. For controlling other process parameters, such as blowdown, the entrained gas measuring device (or controller that receives signals therefrom) would be operatively connected to a controller capable of controlling an automatic valve position or pump speed (% open or % speed) relative to the controlled parameter. In other embodiments, the controller 403 sends signals to the main plant control center 600, which houses a processor that runs software application(s) with one or more control algorithms to perform the above-described functions. Alternatively, one or more of controller 403 and/or main plant control center 600 could be housed or in the cloud, the Internet or intranet, or elsewhere on a remote server which is operatively connected to the inventive system.

In another preferred embodiment, the system operates by providing real-time feedback to the operator of the wet scrubbing system regarding levels of various parameters (e.g., flow rate of defoamer, or flow rate of fresh water into the wet scrubbing system) that should be met in order to decrease or otherwise optimize the level of entrained gasses in the wet scrubbing system, whereby the operator can monitor the system in real- or near-real-time and manually adjust the indicated parameters.

In either of these embodiments, the inventive system could also provide output in the nature of optimized blowdown schedule and/or frequency, designed to reduce or otherwise optimize the volume of entrained gas in the system. Thus, the inventive system could operate for a period of time, shortly after installation and/or at regular or pre-determined intervals, in a “monitoring” mode to record and analyze the impact of various levels of the various processing parameters, or the existing blowdown schedule, on the levels of entrained gas in the system. The system could therefor make recommendations for “optimal” levels of each of the system's parameters, and/or for the blowdown schedule, that would minimize or otherwise optimize the level of entrained gas in the system, and optionally continue to monitor and suggest adjustments to the pre-determined “optimum” levels on a real-time basis to control foaming.

In sum, the system provides a means for a defoamer or antifoam chemistry dosage to be adjusted in real-time to control the entrained gases present. The inventive system could also be used to proactively control blowdown schedule or other operational parameters such as air injection rate for a wide range of wet scrubbing applications.

While the device disclosed herein is particularly useful for use in wet scrubbers predominantly used in many other industrial operations (power, steel, petrochemical, etc.), it is within the scope of the invention disclosed herein to adapt the device to use in other fields.

This application is therefore intended to cover any variations, uses, or adaptations of the invention using its general principles. Further, this application is intended to cover such departures from the present disclosure as come within known or customary practice in the art to which this invention pertains.

We claim:

1. A system comprising:
a wet scrubber;
a sensor for measuring a volume of entrained gas in a fluid;
one or more controls for controlling one or more processing parameters; and
a processor operatively connected to said sensor.

2. The system of claim 1, wherein said one or more processing parameters are selected from the group comprising: a flow rate of antifoam/defoamer chemistry in said wet scrubber, a flow rate of flue gas, a flow rate of fresh water, a conductivity level, a chloride level, a rate of air injection, and/or pH of liquid in the wet scrubber.

3. The system of claim 1, wherein said processor is operatively connected to at least one of said one or more controls and capable of automatically or semi-automatically adjusting at least one of said one or more controls in real time.

4. The system of claim 3, wherein said processor is capable of automatically or semi-automatically adjusting at least one of said one or more controls in real time in response to data representative of a volume of entrained gas in a fluid received from said sensor.

5. The system of claim 1, wherein said sensor is capable of measuring said volume of entrained gas in the recirculation fluid of said wet scrubber in real time.

6. The system of claim 1, wherein said sensor is positioned to measure a volume of entrained gas in a pH test line of said wet scrubber.

7. The system of claim 1, wherein said sensor is positioned to measure a volume of entrained gas in a recirculation line carrying scrubbing liquid to said wet scrubber.

8. The system of claim 1, further comprising one or more additional sensors for measuring a volume of entrained gas in a fluid, and wherein said processor is operatively connected to one or more of said one or more additional sensors.

9. The system of claim 8, wherein said processor collects and analyzes entrained gas measurement data from each of said sensors and provides a control signal based on the totality of said entrained gas measurement data to said one or more controls.

10. The system of claim 9, wherein said one or more controls comprises a defoamer or antifoam dosing pump.

11. The system of claim 9, wherein said one or more controls comprises an automatic valve to control the rate of air injection and/or blowdown into said wet scrubber system.

12. A method for reducing foaming in a wet scrubber system, the method comprising:
measuring a volume of entrained gas in said wet scrubber system;
automatically or semi-automatically adjusting one or more processing parameters to control an amount of foam in said wet scrubber system.

13. The method of claim 12, wherein said one or more processing parameters is selected from a group comprising: a flow rate of antifoam/defoamer chemistry in said wet scrubber, a flow rate of flue gas, a flow rate of fresh water, a conductivity level, a chloride level, and/or pH of liquid in the wet scrubber.
